(19) United States
(12) Patent Application Publication
(10) Pub. No.: US 2020/0250134 A1
(43) Pub. Date: Aug. 6, 2020

(54) SYSTEM AND METHOD FOR ADAPTIVE AGGREGATED SNAPSHOT DELETION

(71) Applicant: EMC IP Holding Company, LLC, Hopkinton, MA (US)

(72) Inventors: Wilson Hu, Beijing (CN); Philippe Armangau, Acton, MA (US); Qiaosheng Zhou, Beijing (CN); Chao Han, Beijing (CN); Shuo Lv, Beijing (CN); Joe Jian Liu, Beijing (CN); Liam Xiongcheng Li, Beijing (CN); Rongrong Shang, Beijing (CN)

(21) Appl. No.: 16/263,528

(22) Filed: Jan. 31, 2019

(51) Int. Cl. G06F 16/11; G06F 9/54; G06F 16/16

(52) U.S. Cl. CPC G06F 16/128; G06F 16/162; G06F 9/54

(57) ABSTRACT

A method, computer program product, and computer system for identifying, by a computing device, a plurality of snapshots within a family. It may be determined that multiple snapshots of the plurality of snapshots within the family are marked for deletion. Truncation of the multiple snapshots may be aggregated based upon, at least in part, determining that the multiple snapshots of the plurality of snapshots within the family are marked for deletion.

### BACKGROUND

In some storage systems, deletions of snapshots (e.g., “snap deletes”) may take a very long time when the snapshot is large (e.g., several hundreds of GBs, or even several TBs) and/or when the storage system is under high I/O pressure. This may cause one or more issues, such as being unable to recycle storage pool spaces in a timely manner, prolonged performance impacts on host I/O, running out of storage space, etc.

### BRIEF SUMMARY OF DISCLOSURE

In one example implementation, a method, performed by one or more computing devices, may include but is not limited to identifying, by a computing device, a plurality of snapshots within a family. It may be determined that multiple snapshots of the plurality of snapshots within the family are marked for deletion. Truncation of the multiple snapshots may be aggregated based upon, at least in part, determining that the multiple snapshots of the plurality of snapshots within the family are marked for deletion.

One or more of the following example features may be included. A pre-truncate application programming interface (API) may be inserted into a state machine. Determining that the multiple snapshots of the plurality of snapshots within the family are marked for deletion may include marking the multiple snapshots for deletion by a Common Block File System (CBFS) layer. The multiple snapshots of the plurality of snapshots within the family marked for deletion may be broken into a plurality of chunks. It may be determined that a next snapshot of the plurality of snapshots within the family was marked for deletion while truncating a first chunk of the plurality of chunks. A next chunk of at least one snapshot of the multiple snapshots and a next chunk of the next snapshot may be truncated together. At least one of a direction of the aggregated truncation of the multiple snapshots may be unchangeable and a size of the next chunk of the next snapshot may be dynamically tunable.

In another example implementation, a computing system may include one or more processors and one or more memories configured to perform operations that may include but are not limited to identifying a plurality of snapshots within a family. It may be determined that multiple snapshots of the plurality of snapshots within the family are marked for deletion. Truncation of the multiple snapshots may be aggregated based upon, at least in part, determining that the multiple snapshots of the plurality of snapshots within the family are marked for deletion.

One or more of the following example features may be included. A pre-truncate application programming interface (API) may be inserted into a state machine. Determining that the multiple snapshots of the plurality of snapshots within the family are marked for deletion may include marking the multiple snapshots for deletion by a Common Block File System (CBFS) layer. The multiple snapshots of the plurality of snapshots within the family marked for deletion may be broken into a plurality of chunks. It may be determined that a next snapshot of the plurality of snapshots within the family was marked for deletion while truncating a first chunk of the plurality of chunks. A next chunk of at least one snapshot of the multiple snapshots and a next chunk of the next snapshot may be truncated together. At least one of a direction of the aggregated truncation of the multiple snapshots may be unchangeable and a size of the next chunk of the next snapshot may be dynamically tunable.

In another example implementation, a computer program product may reside on a computer readable storage medium having a plurality of instructions stored thereon which, when executed across one or more processors, may cause at least a portion of the one or more processors to perform operations that may include but are not limited to identifying a plurality of snapshots within a family. It may be determined that multiple snapshots of the plurality of snapshots within the family are marked for deletion. Truncation of the multiple snapshots may be aggregated based upon, at least in part, determining that the multiple snapshots of the plurality of snapshots within the family are marked for deletion.

One or more of the following example features may be included. A pre-truncate application programming interface (API) may be inserted into a state machine. Determining that the multiple snapshots of the plurality of snapshots within the family are marked for deletion may include marking the multiple snapshots for deletion by a Common Block File System (CBFS) layer. The multiple snapshots of the plurality of snapshots within the family marked for deletion may be broken into a plurality of chunks. It may be determined that a next snapshot of the plurality of snapshots within the family was marked for deletion while truncating a first chunk of the plurality of chunks. A next chunk of at least one snapshot of the multiple snapshots and a next chunk of the next snapshot may be truncated together. At least one of a direction of the aggregated truncation of the multiple snapshots may be unchangeable and a size of the next chunk of the next snapshot may be dynamically tunable.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a truncation process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of FIG. 1 according to one or more example implementations of the disclosure;

FIG. 4 is an example state machine according to one or more example implementations of the disclosure;

FIG. 5 is an example flowchart of a truncation process according to one or more example implementations of the disclosure;

FIG. 6 is an example state machine according to one or more example implementations of the disclosure;

FIG. 7 is an example flowchart of a truncation process according to one or more example implementations of the disclosure; and

FIGS. 8a-8b are example visual steps of aggregated truncation at the chunk level according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

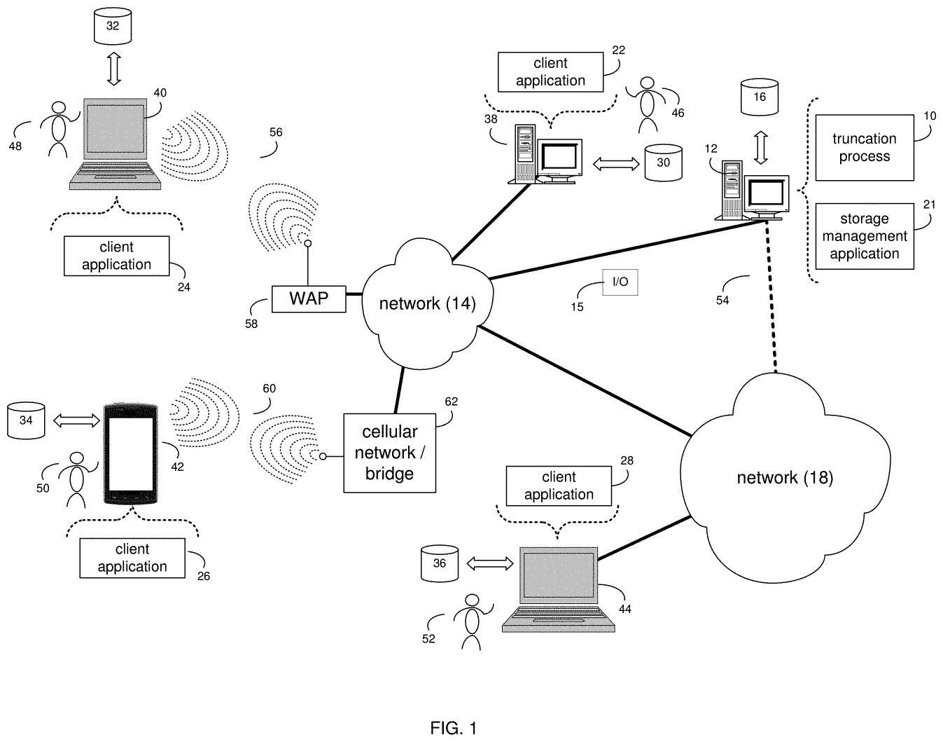

Referring now to the example implementation of FIG. 1, there is shown truncation process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a truncation process, such as truncation process 10 of FIG. 1, may identify, by a computing device, a plurality of snapshots within a family. It may be determined that multiple snapshots of the plurality of snapshots within the family are marked for deletion. Truncation of the multiple snapshots may be aggregated based upon, at least in part, determining that the multiple snapshots of the plurality of snapshots within the family are marked for deletion.

In some implementations, the instruction sets and subroutines of truncation process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, truncation process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a storage management application (e.g., storage management application 21), examples of which may include, but are not limited to, e.g., a storage system application, a cloud computing application, a data synchronization application, a data migration application, a garbage collection application, or other application that allows for the implementation and/or management of data in a clustered (or non-clustered) environment (or the like). In some implementations, truncation process 10 and/or storage management application 21 may be accessed via one or more of client applications 22, 24, 26, 28. In some implementations, truncation process 10 may be a standalone application, or may be an applet/application/script/extension that may interact with and/or be executed within storage management application 21, a component of storage management application 21, and/or one or more of client applications 22, 24, 26, 28. In some implementations, storage management application 21 may be a standalone application, or may be an applet/application/script/extension that may interact with and/or be executed within truncation process 10, a component of truncation process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of truncation process 10 and/or storage management application 21. Examples of client applications 22, 24, 26, 28 may include, but are not limited to, e.g., a storage system application, a cloud computing application, a data synchronization application, a data migration application, a garbage collection application, or other application that allows for the implementation and/or management of data in a clustered (or non-clustered) environment (or the like), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of truncation process 10 (and vice versa). Accordingly, in some implementations, truncation process 10 may be a purely server-side application, a purely client-side application, or a hybrid server-side/client-side application that is cooperatively executed by one or more of client applications 22, 24, 26, 28 and/or truncation process 10.

In some implementations, one or more of client applications 22, 24, 26, 28 may be configured to effectuate some or all of the functionality of storage management application 21 (and vice versa). Accordingly, in some implementations, storage management application 21 may be a purely server-side application, a purely client-side application, or a hybrid server-side/client-side application that is cooperatively executed by one or more of client applications 22, 24, 26, 28 and/or storage management application 21. As one or more of client applications 22, 24, 26, 28, truncation process 10, and storage management application 21, taken singly or in any combination, may effectuate some or all of the same functionality, any description of effectuating such functionality via one or more of client applications 22, 24, 26, 28, truncation process 10, storage management application 21, or combination thereof, and any described interaction(s) between one or more of client applications 22, 24, 26, 28, truncation process 10, storage management application 21, or combination thereof to effectuate such functionality, should be taken as an example only and not to limit the scope of the disclosure.

In some implementations, one or more of users 46, 48, 50, 52 may access computer 12 and truncation process 10 (e.g., using one or more of client electronic devices 38, 40, 42, 44) directly through network 14 or through secondary network 18. Further, computer 12 may be connected to network 14 through secondary network 18, as illustrated with phantom link line 54. Truncation process 10 may include one or more user interfaces, such as browsers and textual or graphical user interfaces, through which users 46, 48, 50, 52 may access truncation process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

Data Storage System:

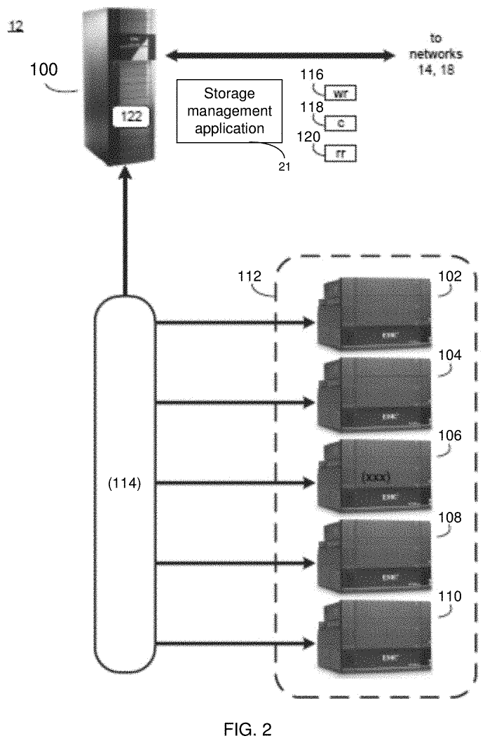

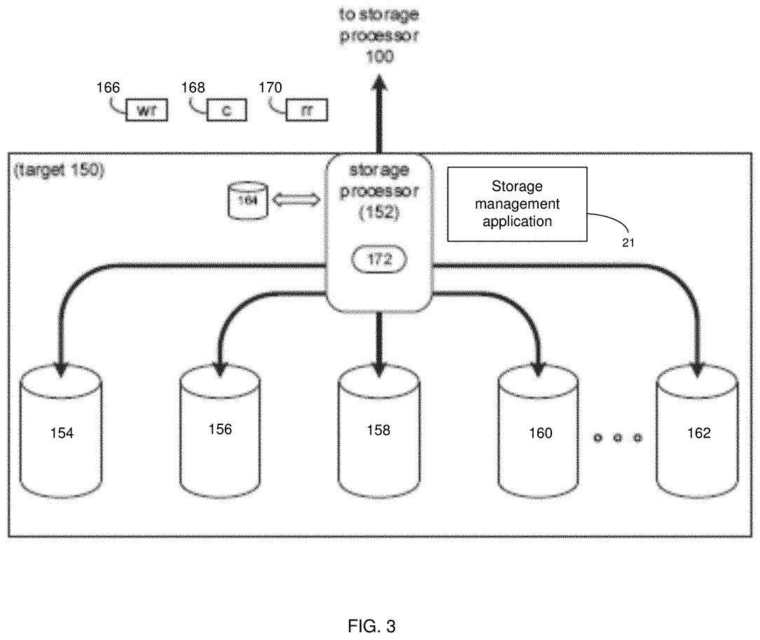

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112.

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™ system offered by Dell EMC™ of Hopkinton, Mass.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or truncation process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VNX™ system offered by Dell EMC™ of Hopkinton, Mass. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

In some storage systems, deletions of snapshots (e.g., snap deletes) may take a very long time when the snapshot is large (e.g., several hundreds of GBs, or even several TBs) and/or when the storage system is under high I/O pressure. This may cause one or more issues, such as being unable to recycle storage pool spaces in a timely manner, prolonged performance impacts on host I/O, etc. Some improvements for this problem have been to leverage merge-weight instead of return-weight. But this improvement is generally limited to single snapshot (also referred to as a snap for short) delete.

Thus, as will be discussed below, if multiple snaps within same family could be truncated in an aggregated way, whole snap delete process may speed up more due to aggregated “destination IB updates,” Unix File System (UFS) log aggregation, aggregated VBM locks, etc. Accordingly, the present disclosure may provide an approach to enabling such aggregation of multiple snap deletes by, e.g., adding a new step (e.g., “pre-truncate-to-zero,” and performing a “snap truncate aggregation” adaptively by, e.g., picking up snap-delete notifications (e.g., by “pre_truncate_to_zero” calls sent for new snap deletes) at the chunk level, while the chunk size may be configured dynamically to balance between “timely snap truncate aggregation” and “snap truncate scheduling overhead.”

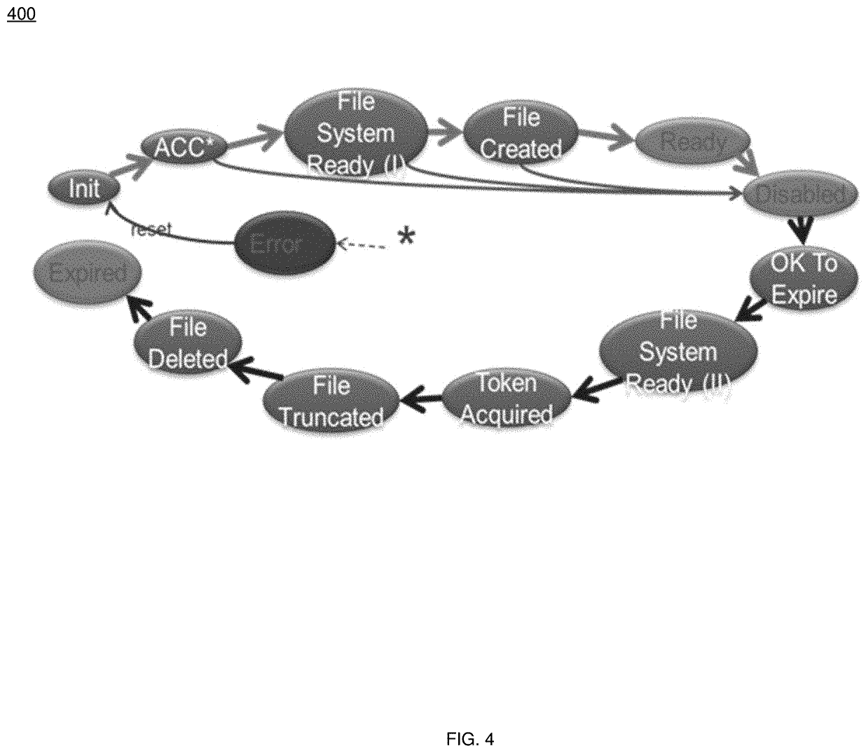

Referring at least to FIG. 4, an example snap delete Mapper Layer Unit (MLU) state machine (e.g., state machine 400) for a past snap delete procedure is shown. Typically, the MLU layer is responsible for running state machine 400, and calls the Common Block File System (CBFS) layer (e.g., through CBFS APIs) to truncate and delete the snap file respectively. In the past, a “snap delete” had the following example two steps, e.g.: truncate_file (e.g., truncate the snap file to zero size), then delete-file (e.g., delete the snap file). As will be discussed below, the present disclosure may add a “pre_truncate_to_zero” before “truncate_file.”

Generally, a primary file and all its snaps compose a file family. To delete a snap file, a token of this family is first acquired, which may prevent any other snaps in the same family from being deleted at the same time. After the family token is acquired, the snap file is typically truncated to zero length, and then it is deleted from its container file system. Once the snap file deletion is done, the family token may be released, and delete-requests on another snap in the same family may then be processed. That is, snaps within same family are typically truncated in serialized manner, so there is no chance to aggregate the snap truncations for better performance.

As will be discussed below, truncation process 10 may at least help, e.g., improve of an existing technology, necessarily rooted in computer technology in order to overcome an example and non-limiting problem specifically arising in the realm of computer data storage associated with, e.g., being integrated into the practical application of snapshot deletion. It will be appreciated that the computer processes described throughout are integrated into one or more practical applications, and when taken at least as a whole are not considered to be well-understood, routine, and conventional functions.

The Truncation Process:

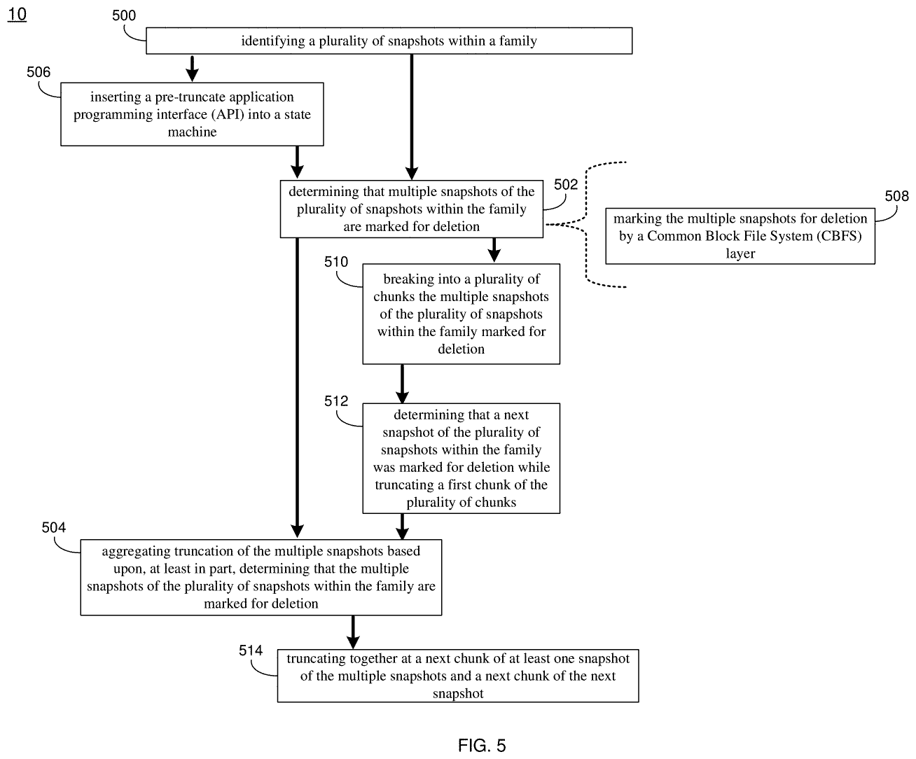

As discussed above and referring also at least to the example implementations of FIGS. 5-8b, truncation process 10 may identify 500, by a computing device, a plurality of snapshots within a family. Truncation process 10 may determine 502 that multiple snapshots of the plurality of snapshots within the family are marked for deletion. Truncation process 10 may aggregate 504 truncation of the multiple snapshots based upon, at least in part, determining that the multiple snapshots of the plurality of snapshots within the family are marked for deletion.

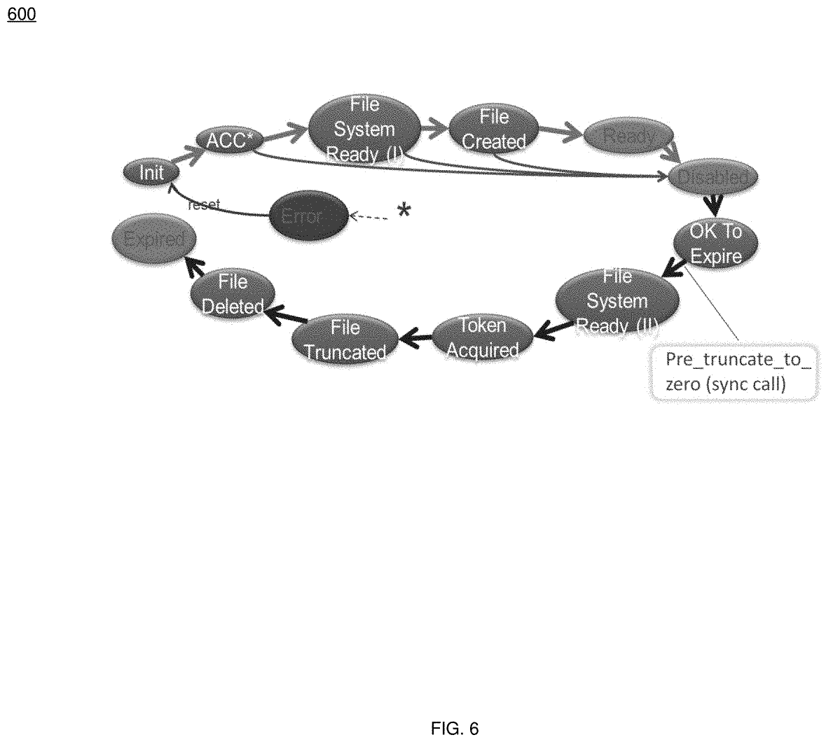

In some implementations, truncation process 10 may identify 500, by a computing device, a plurality of snapshots within a family, and in some implementations, truncation process 10 may determine 502 that multiple snapshots of the plurality of snapshots within the family are marked for deletion. For example, and referring at least to the example implementation of FIG. 6, an example state machine (e.g., state machine 600) is shown. In some implementations, the state machine may include a Mapper Layer Unit (MLU) state machine. However, it will be appreciated that other state machines for different types of storage systems may be used without departing from the scope of the present disclosure.

As noted above, typically, the MLU layer is responsible for running state machine 400, and calls the Common Block File System (CBFS) layer (e.g., through CBFS APIs) to truncate and delete the snap file respectively. However, in some implementations, truncation process 10 may insert 506 a pre-truncate application programming interface (API) into a state machine (e.g., state machine 600). As such, determining 502 that the multiple snapshots of the plurality of snapshots within the family are marked for deletion may include marking 508 the multiple snapshots for deletion by the CBFS layer. For instance, to enable the aggregated truncation of multiple identified 500 snaps within the same family, truncation process 10 may insert 506 the CBFS API named (for example purposes only) “pre_truncate_to_zero.” In the example, the MLU layer (e.g., via truncation process 10) may call this API before acquiring the above-noted family token. In some implementations, the CBFS layer (e.g., via truncation process 10) may register the snap passed in by this API, and mark 508 this snap “to be truncated to zero” (after the token acquired).

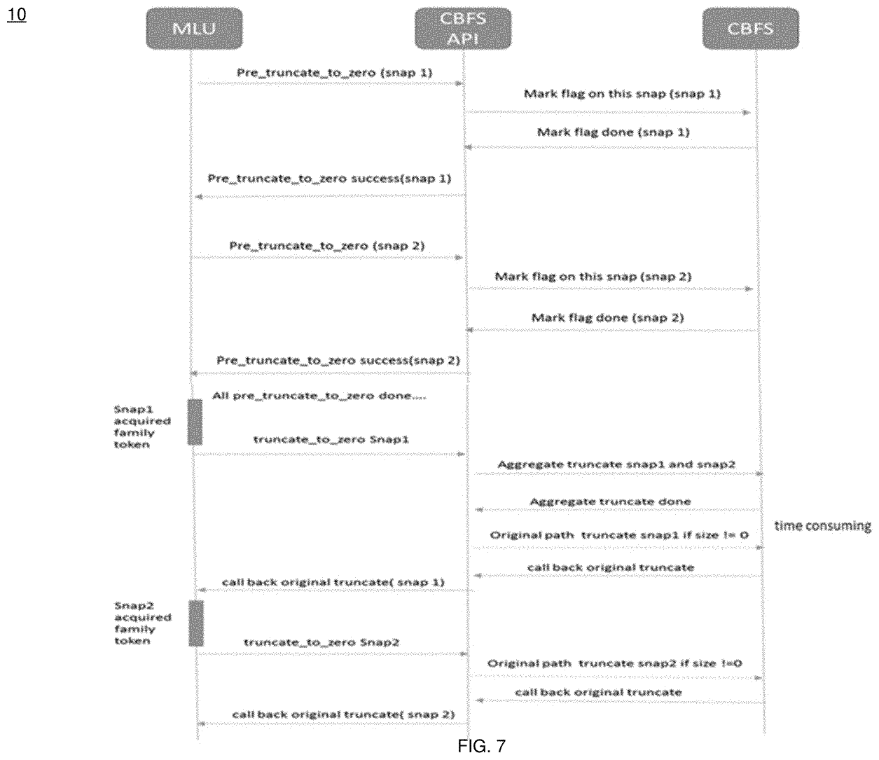

For the same family, when multiple identified snap delete requests are sent to the MLU layer before one of them gets the token, once one of them does get the token and starts truncation (e.g., call CBFS API (for example purposes only) “truncate_file”), the CBFS layer may see and determine 502 that other snaps are also marked “to be truncated to zero,” thus, truncation process 10 (e.g., via the CBFS function “truncate_file”) may have the chance to truncate all these snaps together. As shown in FIG. 6, it can be seen where the “pre_truncate_to_zero” API is inserted 506 within the previous MLU state machine (compared with FIG. 4). An alternative flowchart of truncation process 10 (which may be used in any combination with the flowchart shown in FIG. 5) is shown in FIG. 7.

In some implementations, truncation process 10 may aggregate 504 truncation of the multiple snapshots based upon, at least in part, determining that the multiple snapshots of the plurality of snapshots within the family are marked for deletion. For instance, as can be seen, the most time consuming step with FIG. 7 may be the actual “snap truncation.” With the pre_truncate_to_zero API introduced, snap1 and snap2 may be aggregated and thus truncated together to zero length (e.g., if no exception happens during aggregated truncation). Once snap2 gets the family token, truncation process 10 actually has nothing to truncate further, so snap2 will be deleted by truncation process 10 within no time.

However, the above snap truncation aggregation may, in some implementations, only happen when the snap2 delete request is sent down to the MLU layer before the start of the snap1 truncation. As such, the time window may be very small unless there is already another snap within the family already under truncation, which may force snap1 and snap2 to wait on the family token together.

In some implementations, truncation process 10 may break 510 into a plurality of chunks the multiple snapshots of the plurality of snapshots within the family marked for deletion. For instance, to help address the above issue, truncation process 10 may further improve the process to aggregate more snaps in the truncation phase. For instance, once some snap(s) start truncation, any new snap delete requests in this family may be ignored by the ongoing truncation. However, for large snaps, truncation may be very time consuming, and as such, if truncation process 10 cannot aggregate new snap delete requests with ongoing snap truncation, the chance of snap truncate aggregation may be somewhat limited. To avoid such a situation, as will be discussed below, truncation process 10 may break 510 into a plurality of chunks the multiple snapshots of the plurality of snapshots within the family marked for deletion.

For instance, truncation process 10 may determine 512 that a next snapshot of the plurality of snapshots within the family was marked for deletion while truncating a first chunk of the plurality of chunks, and truncation process 10 may truncate 514 together a next chunk of at least one snapshot of the multiple snapshots and a next chunk of the next snapshot. For example, aggregation can be improved by truncation process 10 breaking 510 ongoing snap truncation into chunks and detecting new snap delete requests before truncating the next chunk. In some implementations, once the CBFS layer (e.g., via truncation process 10) finishes truncation of one chunk, it may detect if there are any other snaps in same family having been marked 508 “to be truncated to zero” while the last chunk of truncation was ongoing. In the example, if such snaps are found, these snaps may be aggregated and truncated together with the existing ones at the next chunk.

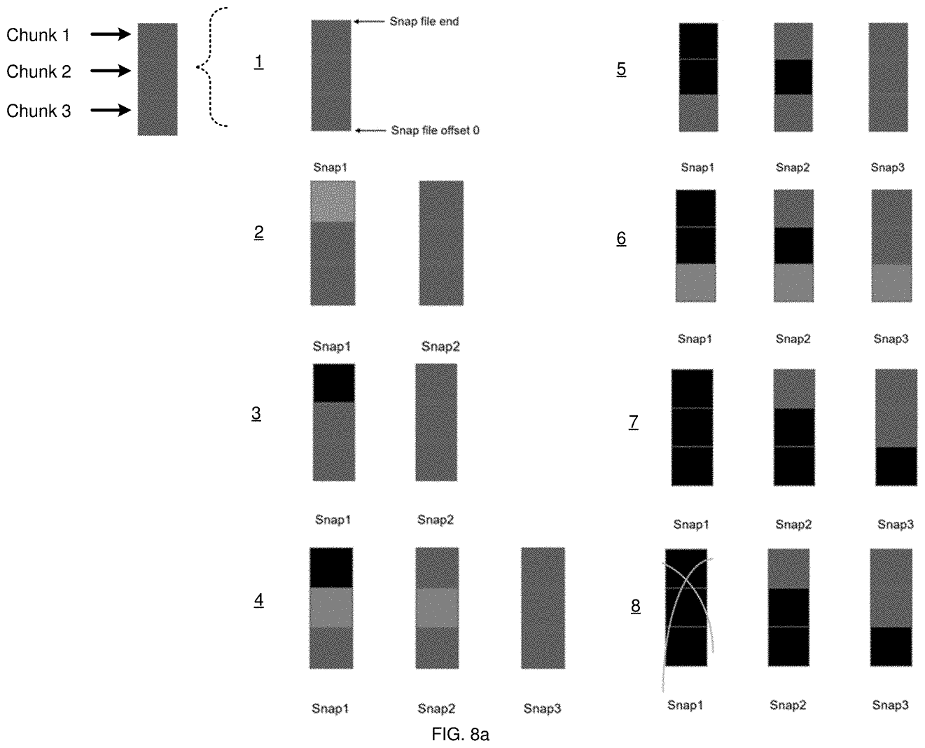

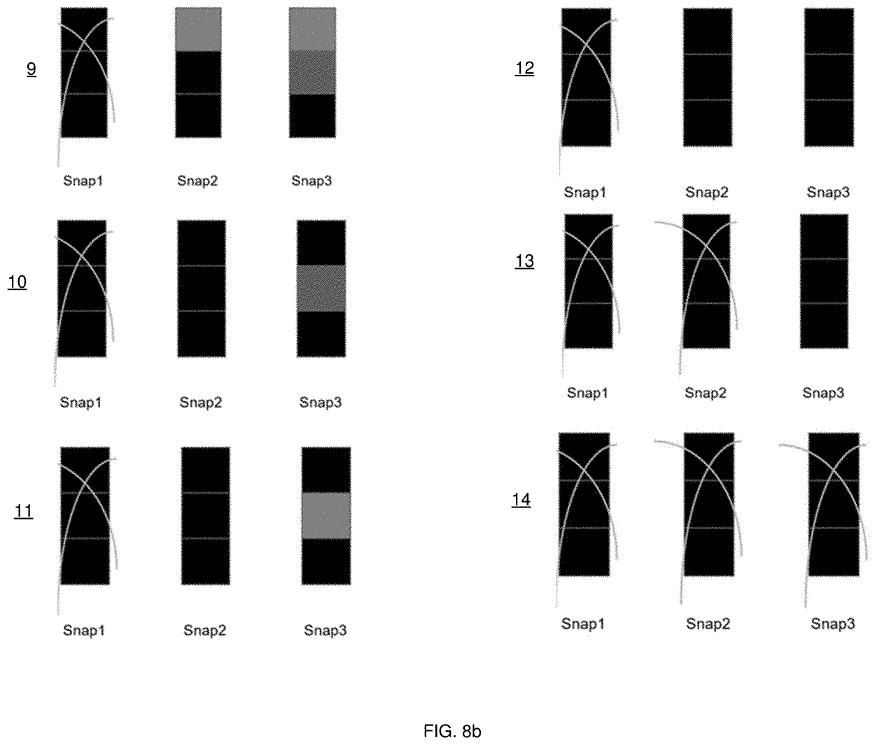

For example, and referring at least to the example implementation of FIG. 8a and FIG. 8b, example steps showing the progression of the “chunk level snap delete aggregation” are shown. In the example, in step 1, snap1 (via truncation process 10) gets the above-noted family token, which causes the start of truncation from “snap file end” to “snap file offset 0.”

In step 2, the CBFS (via truncation process 10) is truncating the first chunk of snap1. Before truncation is complete, assume the MLU (via truncation process 10) receives a delete request for snap2. In the example, CBFS (via truncation process 10) marks snap2 “to be truncated to zero” as a result of the above-noted “pre_truncation_zero” API.

In step 3, the CBFS (via truncation process 10) finishes truncating the first chunk of snap1. Before starting to truncate the next chunk (e.g., chunk 2), the CBFS (via truncation process 10) detects that snap2 is “to be truncated to zero,” so the CBFS (via truncation process 10) will truncate both snap1 and snap2 at the next chunk (chunk 2).

In step 4, the CBFS (via truncation process 10) is truncating chunk 2 of snap1 and snap2 together. Before truncation is complete, the MLU (via truncation process 10) receives the delete request for snap3, and the CBFS (via truncation process 10) marks snap3 “to be truncated to zero” as the result of the “pre_truncation_zero” API.

In step 5, the CBFS (via truncation process 10) finishes truncating chunk 2 of snap1 and snap2. Before the start of truncating the next chunk (e.g., chunk 3), the CBFS (via truncation process 10) detects that snap3 is “to be truncated to zero,” so the CBFS (via truncation process 10) will truncate these 3 snap3 together at the next chunk (e.g., chunk 3).

In step 6, the CBFS (via truncation process 10) is truncating chunk 3 of the 3 snaps together. Assume now that no new snap delete requests are received during the truncation.

In step 7, the CBFS (via truncation process 10) finishes truncating chunk 3 of these 3 snaps. Assume that by this time, snap1 is totally truncated. The “truncate_file” CBFS API callback to the MLU indicates that snap1 truncation is complete.

In step 8, the MLU (via truncation process 10) calls the CBFS to delete snap1. After snap1 is deleted, the family token may be released. Snap2 (via truncation process 10) now gets the family token, and truncation process 10 will now start truncation from the snap2 file end to offset 0. Before the starting to truncate the first chunk of snap2, the CBFS (via truncation process 10) detects that snap3 is “to be truncated to zero” (e.g., marked at step 4)), so the CBFS (via truncation process 10) will truncate snap2 and snap3 together at the first chunk (chunk 1).

In step 9, the CBFS (via truncation process 10) is truncating chunk 1 of the snap2 and snap3 together. Assume no new snap delete requests come in during the truncation.

In step 10, the CBFS (via truncation process 10) finishes truncating chunk 1 of snap2 and snap3. Before truncating the next chunk (chunk 2) of snap2 and snap3, assume the CBFS (via truncation process 10) finds no other snap marked “to be truncated to zero.”

In step 11, the CBFS (via truncation process 10) is truncating chunk 2 of snap2 and snap3. Note that the second chunk of snap2 was already truncated at step 5 with snap1, so essentially, this step only needs to truncate chunk 2 of snap3. Assume now for example purposes only that no new snap delete request comes in during the truncation.

In step 12, the CBFS (via truncation process 10) finishes truncating chunk 2 of snap3. Before truncating the next chunk (chunk 3) of snap2 and snap3, the CBFS (via truncation process 10) finds no other snap marked “to be truncated to zero.” Since chunk 3 of snap2 and snap3 were already truncated at step 7, there is essentially nothing to do. By this time, both snap2 and snap3 are fully truncated. The “truncate_file” CBFS API callback to the MLU notifies the truncation of snap2 is complete.

In step 13, the MLU (via truncation process 10) calls the CBFS to delete snap2. After snap2 is deleted, the family token is released. Assume that Snap3 (via truncation process 10) now gets the family token, and the MLU calls the CBFS to truncate snap3 from the file end to offset 0 of snap3. The CBFS (via truncation process 10) finds that snap3 is already fully truncated, so the CBFS (via truncation process 10) notifies the MLU that truncation is done.

In step 14, the MLU (via truncation process 10) calls the CBFS to delete snap3. After snap3 is deleted, the family token is released. Now, all three snaps in this family are deleted, completing the aggregation and deletion of multiple snaps in a family.

In some implementations, a direction of the aggregated truncation of the multiple snapshots may be unchangeable. For example, as a background service, the response time of a single snap delete request may not need to be worried about much, but it still should be reasonable. To help guarantee this, the addition of new snaps at the next chunk of truncation may not change the truncation direction for the snap that is currently holding the family token (such as snap1 in above example). That is, in some implementations, the direction may be always from snap file end to offset 0, chunk by chunk.

In some implementations, a size of the next chunk of the next snapshot may be dynamically tunable. For example, there may be an upper limit of how many snaps may be aggregated at a chunk. This may provide further guarantees to single snap delete response time, while at the same time asks for limited memory and storage budget. The truncation chunk size may be tuned dynamically (e.g., by an administrator) to balance between the scheduling overhead and the ability to detect and aggregate new snap delete requests in a timely manner. In some implementations, using truncation process 10, the impact of the snap delete to the host I/O may be almost the same, regarding host I/O response time and CPU usage. However, compared with a baseline performance that does not use truncation process 10, the overall snap delete duration may decrease significantly (e.g., about 60%).

Without chunk-level truncation aggregation, in above example, snap1 will likely have no chance to be truncated together with other snaps within the same family. Once the CBFS layer is given the chance to aggregate snap truncations of the same family, the CBFS layer may do a lot at the lower level to speed up truncation while keeping similar impact to the host I/O.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, a plurality of snapshots within a family;
determining that multiple snapshots of the plurality of snapshots within the family are marked for deletion; and
aggregating truncation of the multiple snapshots based upon, at least in part, determining that the multiple snapshots of the plurality of snapshots within the family are marked for deletion.

2. The computer-implemented method of claim 1 further comprising inserting a pre-truncate application programming interface (API) into a state machine.

3. The computer-implemented method of claim 1 wherein determining that the multiple snapshots of the plurality of snapshots within the family are marked for deletion includes marking the multiple snapshots for deletion by a Common Block File System (CBFS) layer.

4. The computer-implemented method of claim 1 further comprising breaking into a plurality of chunks the multiple snapshots of the plurality of snapshots within the family marked for deletion.

5. The computer-implemented method of claim 4 further comprising determining that a next snapshot of the plurality of snapshots within the family was marked for deletion while truncating a first chunk of the plurality of chunks.

6. The computer-implemented method of claim 5 further comprising truncating together at a next chunk of at least one snapshot of the multiple snapshots and a next chunk of the next snapshot.

7. The computer-implemented method of claim 6 wherein at least one of:
a direction of the aggregated truncation of the multiple snapshots is unchangeable; and
a size of the next chunk of the next snapshot is dynamically tunable.

8. A computer program product residing on a computer readable storage medium having a plurality of instructions stored thereon which, when executed across one or more processors, causes at least a portion of the one or more processors to perform operations comprising:
identifying a plurality of snapshots within a family;
determining that multiple snapshots of the plurality of snapshots within the family are marked for deletion; and
aggregating truncation of the multiple snapshots based upon, at least in part, determining that the multiple snapshots of the plurality of snapshots within the family are marked for deletion.

9. The computer program product of claim 8 wherein the instructions further comprise inserting a pre-truncate application programming interface (API) into a state machine.

10. The computer program product of claim 8 wherein determining that the multiple snapshots of the plurality of snapshots within the family are marked for deletion includes marking the multiple snapshots for deletion by a Common Block File System (CBFS) layer.

11. The computer program product of claim 8 wherein the instructions further comprise breaking into a plurality of chunks the multiple snapshots of the plurality of snapshots within the family marked for deletion.

12. The computer program product of claim 11 wherein the instructions further comprise determining that a next snapshot of the plurality of snapshots within the family was marked for deletion while truncating a first chunk of the plurality of chunks.

13. The computer program product of claim 12 wherein the instructions further comprise truncating together at a next chunk of at least one snapshot of the multiple snapshots and a next chunk of the next snapshot.

14. The computer program product of claim 13 wherein at least one of:
a direction of the aggregated truncation of the multiple snapshots is unchangeable; and
a size of the next chunk of the next snapshot is dynamically tunable.

15. A computing system including one or more processors and one or more memories configured to perform operations comprising:
identifying a plurality of snapshots within a family;
determining that multiple snapshots of the plurality of snapshots within the family are marked for deletion; and
aggregating truncation of the multiple snapshots based upon, at least in part, determining that the multiple snapshots of the plurality of snapshots within the family are marked for deletion.

16. The computing system of claim 15 wherein the instructions further comprise inserting a pre-truncate application programming interface (API) into a state machine.

17. The computing system of claim 15 wherein determining that the multiple snapshots of the plurality of snapshots within the family are marked for deletion includes marking the multiple snapshots for deletion by a Common Block File System (CBFS) layer.

18. The computing system of claim 15 wherein the instructions further comprise breaking into a plurality of chunks the multiple snapshots of the plurality of snapshots within the family marked for deletion.

19. The computing system of claim 18 wherein the instructions further comprise determining that a next snapshot of the plurality of snapshots within the family was marked for deletion while truncating a first chunk of the plurality of chunks.

20. The computing system of claim 19 wherein the instructions further comprise truncating together at a next chunk of at least one snapshot of the multiple snapshots and a next chunk of the next snapshot.
